(19) United States
(12) Patent Application Publication
(10) Pub. No.: US 2006/0202804 A1
(43) Pub. Date: Sep. 14, 2006

(54) Sleep command for active RF tags to prolong battery life

(75) Inventors: Vijay-Pillai, Mukilteo, WA (US); Harley Heinrich, Snohomish, WA (US); Rene Martinez, Seattle, WA (US)

Correspondence Address: BRIAN M BERLINER, ESQ;O'MELVENY & MYERS, LLP, 400 SOUTH HOPE STREET, LOS ANGELES, CA, 90071-2899, US

(73) Assignee: INTERMEC IP CORP.,

(21) Appl. No.: 11/372,563

(22) Filed: Mar. 9, 2006

Related U.S. Application Data
(60) Provisional application No. 60/660,373, filed on Mar. 9, 2005.

(51) Int. Cl. H04Q 5/22; H04B 1/16

(52) U.S. Cl. 340/10.33; 455/343.2

(57) ABSTRACT

Systems and methods are provided for prolong the life of power supplies (e.g., batteries) for RF transponders, such as RFID tags. The method includes receiving one or more RF signals, determining whether one of the RF signals comprises a sleep command, and deactivating the primary circuit of the RF transponder upon determining that one of the received RF signals comprises the sleep command. The primary circuit can be deactivated by disconnecting the power supply, deactivating the primary circuit's clock, etc. The method can also include determining whether one of the received RF signals comprises a wake-up command, and activating the primary circuit upon determining that one of the received RF signals comprises the wake-up command. 411951-253

### CROSS-REFERENCE TO RELATED APPLICATION

This application claims priority pursuant to 35 U.S.C. § 119(e) to U.S. Provisional Application No. 60/660,373, filed Mar. 9, 2005, which application is specifically incorporated herein, in its entirety, by reference.

### BACKGROUND OF THE INVENTION

1. Field of the Invention

The present invention relates to radio frequency (RF) transponders and radio frequency identification (RFID) systems, and more particularly, to a battery-powered RF transponder having a circuit adapted to deactivate (e.g., power down, etc.) at least a portion of the RF transponder circuitry upon receiving a “sleep” command (or signal).

2. Description of Related Art

In the automatic data identification industry, the use of RF transponders (also known as RF tags) has grown in prominence as a way to track data regarding an object on which an RF transponder is affixed. An RF transponder generally includes a semiconductor memory in which information may be stored. An RF interrogator containing a transmitter-receiver unit is used to query (or interrogate) an RF transponder that may be at a distance from the interrogator. The RF transponder detects the interrogating signal and transmits a response signal containing encoded data back to the interrogator. RF and RFID systems are used in applications such as inventory management, security access, personnel identification, factory automation, automotive toll debiting, and vehicle identification, to name just a few.

Such RFID systems provide certain advantages over conventional optical indicia recognition systems (e.g., bar code symbols). For example, the RF transponders may have a memory capacity of several kilobytes or more, which is substantially greater than the maximum amount of data that may be contained in a conventional one-dimensional bar code symbol. The RF transponder memory may be re-written with new or additional data, which would not be possible with a printed bar code symbol. Moreover, RF transponders may be readable at a distance without requiring a direct line-of-sight view by the interrogator, unlike bar code symbols that must be within a direct line-of-sight and which may be entirely unreadable if the symbol is obscured or damaged. An additional advantage of RFID systems is that several RF transponders can be read by the interrogator at one time.

RF transponders may either be “active,” in which they include an internal power source (i.e., battery), or “passive,” in which they do not include a battery and derive their energy entirely from the interrogating signal provided by the RF interrogator. The active RF transponders generally have a greater transmitting range than passive transponders, but have the associated disadvantage of greater bulk due to the inclusion of the battery. The operational life of an active RF transponder is dependent upon the capacity of the battery, and it is generally desirable that an RF transponder have as long of an operational life as possible (e.g., longer than five years). Even though the circuitry of the RF transponder draws relatively low current, the battery will quickly run down if the circuitry is powered up continuously.

To conserve the battery power, the RF transponder may place itself in a low power (or “sleep”) mode in between operations. This is generally accomplished through the use of a “sleep” circuit that monitors the received RF signal(s) and removes power from (i.e., powers down) a primary portion of the RF transponder circuitry if an RF signal (e.g., any RF signal, an RF signal within a particular bandwidth, etc.) is not received for a predetermined period of time. A “wake-up” circuit is then used to restore power to (i.e., power on) the RF transponder circuitry when an (appropriate) RF signal is received.

A drawback of this type of operation is that the RF transponder circuitry remains active (at least for some amount of time) even though it is not being interrogated. For example, if RF signals are no longer present, the RF circuitry will remain active while the “sleep” circuit confirms (for a predetermined period of time) that RF signals are no longer being received. As another example, if RF signals unrelated to a particular RF transponder (e.g., noise, etc.) are being transmitted (and therefore received by the particular transponder), the RF circuitry will remain active until the “sleep” circuit recognizes that the received RF signals are unrelated. If the “sleep” circuit is incapable of distinguishing the received signals from related signals (e.g., proper interrogation signals, etc.), the RF circuitry will remain active until the environment changes or the battery is drained.

Accordingly, it would be very desirable to provide a system and method of using a “sleep” command (or signal) (e.g., as transmitted by an RFID interrogator, etc.), and a circuit associated therewith, to force at least a portion of the RF transponder circuitry into a “sleep” mode.

### SUMMARY OF THE INVENTION

The present invention addresses the shortcomings of the prior art systems and methods. In particular, the present invention is directed to a system and method for prolonging the power supply life of an RF transponder or tag.

In accordance with one aspect of the embodiments described herein, there is provided an RF transponder, comprising: a primary circuit adapted to receive and process RF signals; a power control circuit; a power supply operatively coupled to the primary circuit and the power control circuit; and a switch coupled to the power supply, the primary circuit, and the power control circuit.

In one embodiment, the primary circuit or circuitry is connected to the power supply when the switch is in a first state, and disconnected from the power supply when the switch is in a second state. The primary circuit is adapted to provide a sleep signal to the power control circuit upon detecting a sleep command in one of the received RF signals. The power control circuit can be adapted to toggle the switch from the first to the second state upon receiving the sleep signal, thereby deactivating the primary circuit to reduce power consumption by the RF transponder.

In another embodiment, the primary circuit is further adapted to provide a wake-up signal to the power control circuit upon detecting a wake-up command in one of the received RF signals. The power control circuit can be further adapted to toggle the switch from the second to the first state upon receiving the wake-up signal, thereby activating the primary circuit.

In accordance with another aspect of the embodiments described herein, there is provided an RF transponder, comprising: a primary circuit adapted to receive and process RF signals and a clock control circuit. The primary circuit is adapted to provide a sleep signal to the clock control circuit upon detecting a sleep command in one of the received RF signals. The clock control circuit can be adapted to transmit a stop-clock signal to the primary circuit upon receiving the sleep signal. The stop-clock signal disables a clock of the primary circuit, thereby deactivating the primary circuit to reduce power consumption by the RF transponder.

In another embodiment, the primary circuit is further adapted to provide a wake-up signal to the clock control circuit upon detecting a wake-up command in one of the received RF signals. The clock control circuit can be further adapted to provide a start-clock signal to the primary circuit to activate the clock, thereby activating the primary circuit.

A more complete understanding of the disclosed system and method for the prolonging the power supply life of RF transponders will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a plan view of an RF transponder having a battery;

FIG. 2 is a block diagram of an RF transponder that operates in accordance with one embodiment of the present invention;

FIG. 3 is a block diagram of an RF transponder that operates in accordance with another embodiment of the present invention; and

FIG. 4 illustrates a method of operating an RF transponder in accordance with one embodiment of the present invention.

### DETAILED DESCRIPTION OF THE PREFERRED EMBODIMENT

The present invention satisfies the need for a system and method of using a sleep command (or signal) (e.g., as transmitted by an RFID interrogator, etc.), and a circuit associated therewith (e.g., power control circuit, clock control circuit, etc.), to force at least a portion of the RF transponder circuitry into a “sleep” mode. In the detailed description that follows, like element numerals are used to describe like elements illustrated in one or more of the aforementioned figures.

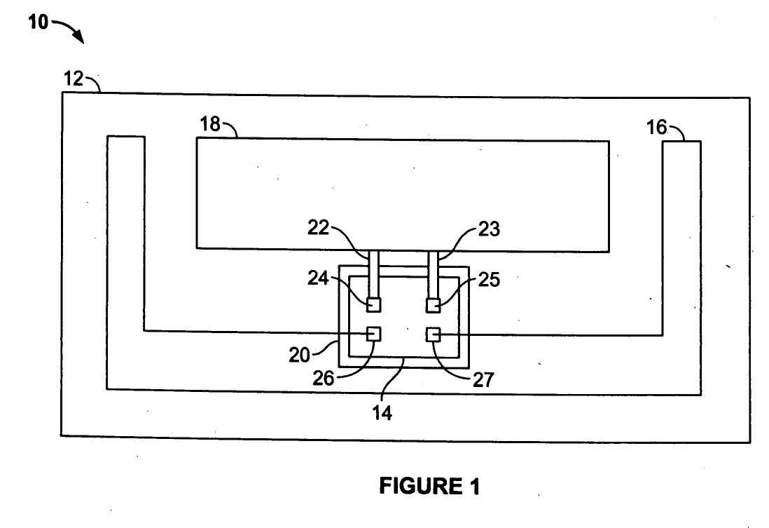

Referring first to FIG. 1, a plan view of a thin, flexible RF transponder 10 is illustrated. The RF transponder 10 includes an integrated circuit 14 mounted on a substrate 12. As known in the art, the integrated circuit 14 includes RF receive/transmit circuits, signal processing logic, and memory. The integrated circuit 14 is connected to an antenna 16 disposed on the substrate 12 through contacts 26, 27. A thin battery 18 is connected to the integrated circuit 14 by leads 22, 23 bonded at contacts 24, 25, respectively. The RF transponder 10 may be kept thin by placing the battery 18 adjacent to the integrated circuit 14 on the substrate 12 rather than stacking the elements. The antenna 16 may also be disposed adjacent to the integrated circuit 14 without stacking. The battery 18 may have a flat form factor with a thickness of about 0.25 mm enabling it to have a flexible structure. The substrate 12 may be comprised of a flexible material, such as polyimide or polyester. The battery 18 may be attached to the substrate 12 using known techniques, such as soldering, conducting adhesive, spot welding and wire bonding. The integrated circuit 14 may also be attached to the substrate 12 using known techniques, such as thermo-compression bonding used in tape automated bonding (TAB) technology, wire bonding, or flip-chip die attach. It should be appreciated, however, that the present invention is not limited to the number and/or location of the components illustrated in FIG. 1, or the manner in which they are constructed and/or connected. The components are merely provided (and discussed herein) to illustrate one exemplary environment in which the present invention may operate. Thus, for example, an RF transponder having a different battery and/or antenna type are within the spirit and scope of the present invention.

Referring back to FIG. 1, an interrogator (not shown) initiates communication with the RF transponder 10 by emitting an RF interrogating field. In between periods of communication with the interrogator, the RF transponder must listen for the presence of an interrogating field. When the RF transponder 10 is in the periphery of the interrogating field, the RF receive circuitry produces a signal voltage level that may be too small (e.g., much less than 100 mV) to be detected. Furthermore, when the RF transponder 10 is located near an RF producing and/or receiving device (e.g., another RF transponder, etc.), the RF receive circuitry may receive a signal that is unrelated to the RF transponder 10. It should be appreciated that the battery would quickly become discharged if the RF receive circuitry were powered continuously by the battery 18 listening for the interrogating field, and hence, the RF transponder 10 would have a shortened “shelf-life.” This is particularly problematic in RF transponders having thin form factor batteries, in view of their small capacity.

In accordance with one embodiment of the present invention, a circuit (e.g., power control circuit, clock control circuit, etc.) is adapted to receive a “sleep” signal (or command) and to deactivate at least a portion of the RF transponder circuitry in response thereto. In accordance with another embodiment of the present invention, the circuit is further adapted to activate the RF transponder circuitry, or portion thereof, in response to receiving a “wake-up” command.

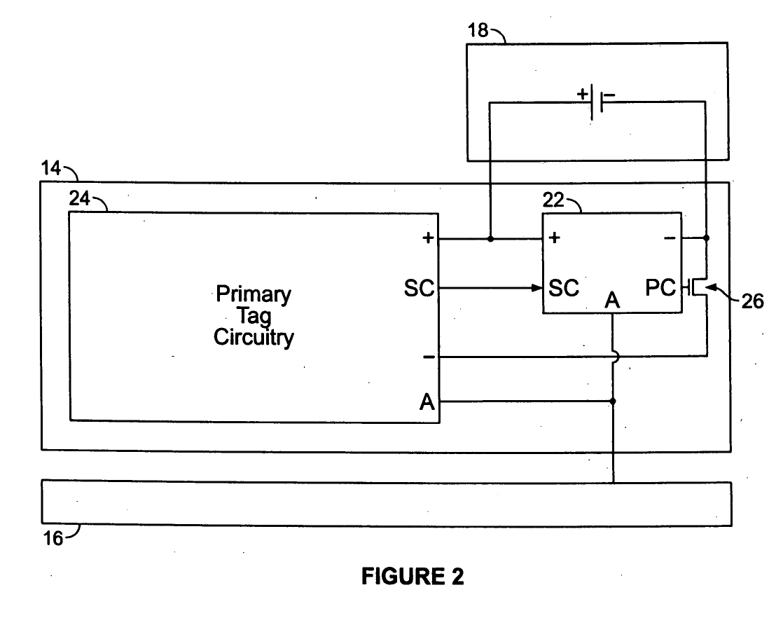

FIG. 2 illustrates a block diagram of an RF transponder that operates in accordance with one embodiment of the present invention. In this embodiment, the integrated circuit 14 includes a primary portion of the RF transponder circuitry (i.e., primary tag circuitry) 24 and a power control circuit 22, wherein the primary tag circuitry 24 is adapted to receive an RF signal (e.g., an interrogation signal, etc.), process the received RF signal (e.g., decode, perform requested operations, etc.), and transmit a modulated RF signal. Both the primary tag circuitry 24 and the power control circuit 22 are connected to the antenna 16, and thus are adapted to receive incoming RF signals. The power control circuit 22, however, is the only circuit that is permanently connected to the battery 18.

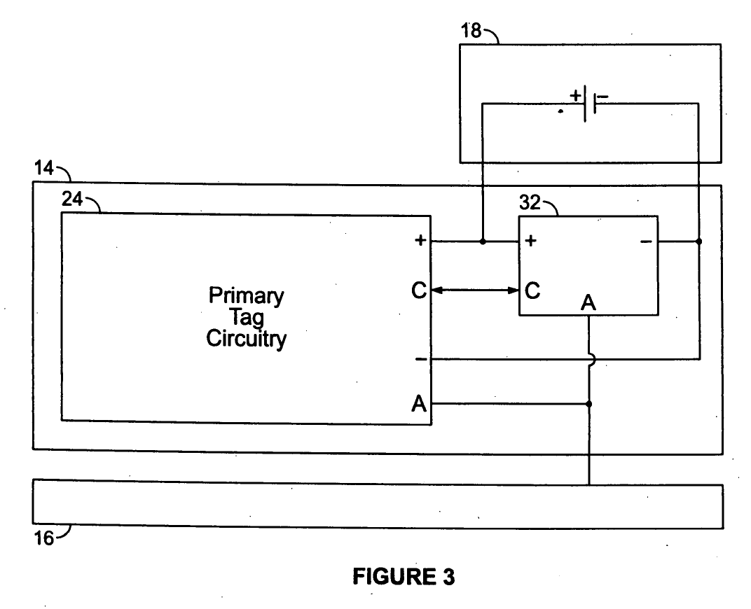

The primary tag circuitry 24 is only connected to the battery via a switch 26 (e.g., transistor, etc.), which is controlled by the power control circuit 22. Specifically, a first end of the switch 26 is connected to a negative lead of the battery 18, a second end of the switch 26 is connected to a negative input of the primary tag circuitry 24, and a switching portion of the switch 26 (e.g., gate, etc.) is connected to a power control (pc) pin on the power control circuit 22. By toggling the pc pin, the power control circuit 22 can control the power that is applied to the primary tag circuitry 24. It should be appreciated that the number and/or location of devices depicted in FIGS. 2 and 3 are not to be considered limitations of the present invention, but are merely provided to illustrate the environment in which the present invention may operate. Thus, for example, an RF transponder including two or more integrated circuits, a single circuit adapted to perform the functions of both the primary tag circuitry and the power control circuit, and/or a remotely located antenna are within the spirit and scope of the present invention. It should further be appreciated that the present invention is not limited to any particular type of switching device, and includes all switching devices generally known to those skilled in the art.

In a first embodiment of the present invention, the primary tag circuitry 24 is adapted to receive a sleep command from an RFID interrogator (not shown) and to provide a sleep signal to the power control circuit 22 via a sleep control (sc) pin(s). The power control circuit 22 is then adapted to toggle the pc pin so that the power provided to the primary tag circuitry 24 is disconnected. In other words, the sleep command is used (either directly or indirectly) to deactivate the primary tag circuitry 24, thereby reducing the power consumed by the RF transponder. It should be appreciated that the present invention is not limited to the use of a sleep control pin. Thus, for example, an RF transponder that includes a power control circuit adapted to receive a sleep command directly from an RFID interrogator or primary tag circuitry adapted to deactivate itself is within the spirit and scope of the present invention.

In a second embodiment of the present invention, the power control circuit 22 is further adapted to receive a wake-up command from the RFID interrogator (not shown) and to toggle the pc pin so that power is restored to the primary tag circuitry 24. In other words, the power control circuit 22 is adapted to activate the primary tag circuitry in response to receiving the wake-up command. It should be appreciated, however, that the structure of the wake-up command (e.g., its length, header, complexity, etc.) may be similar or different than the structure of the sleep command. Thus, for example, a wake-up command comprising a shorter (or simpler) command structure than the sleep command, thus making it easier to decode, is within the spirit and scope of the present invention.

In another embodiment of the present invention, the power control circuit 22 further includes a voltage regulation circuit (not shown). In an active device, the regulation circuit may be used to regulate the voltage produced by an on-board power source (e.g., a battery). In a dual active/passive device, the regulation circuit may further (or alternatively) be used to regulate the voltage extracted from a received RF signal (e.g., interrogating signal, etc.). The regulated voltage is then used to power the primary tag circuitry 24. With respect to FIG. 2, for example, the components should be arranged so that voltage from the battery 18 is delivered to the primary tag circuitry 24 via the voltage regulation circuit (not shown) and the switch 26. It should be appreciated, however, that the present invention is not limited to components being arranged in any particular manner. Thus, for example, a integrated circuit that regulates voltage before (or after) the voltage is pass through a power-control switch is within the spirit and scope of the present invention. Is should further be appreciated that the present invention is not limited to any particular type of voltage regulation circuit, and includes all power regulating circuits, analog and digital, fixed and programmable, generally known to those skilled in the art.

FIG. 3 illustrates a block diagram of an RF transponder that operates in accordance with another embodiment of the present invention. In this embodiment, the integrated circuit 14 includes a primary portion of the RF transponder circuitry (i.e., primary tag circuitry) 24 and a clock control circuit 32, wherein the primary tag circuitry 24 operates (at least generally) as previously described (e.g., receiving/transmitting RF signals, etc.). Both the primary tag circuitry 24 and the clock control circuit 32 are connected to both the antenna 16 and the battery 18 via respective leads. In this embodiment, the primary tag circuitry 24 and the clock control circuit 32 are further adapted to communicate with one another via a control line(s). In other words, the control line (c) allows information (e.g., commands, signals, etc.) to be communicated between the clock control circuit 32 and the primary tag circuitry 24.

In a third embodiment of the present invention, the primary tag circuitry 24 is adapted to receive a sleep command from an RFID interrogator (not shown) and to provide a sleep signal to the clock control circuit 32 via the control pin (c). The clock control circuit 32 is then adapted to provide a stop-clock signal to the primary tag circuitry 24 via the control line (c). This results in the primary tag circuitry's clock (e.g., clocking circuit, oscillation circuit, etc.) being disabled, thereby effectively deactivating the primary tag circuitry 24. By stopping (or substantially reducing) the clock of the primary tag circuitry, power consumed is reduced. It should be appreciated that the present invention is not limited to the use of a bi-directional control line for communicating the aforementioned information. Thus, for example, an RF transponder that includes multiply control lines (e.g., first control line(s) for communicating information to the clock control circuit, second control line(s) for communicating information to the clocking circuit, etc.), a clock control circuit adapted to receive a sleep command directly from an RFID interrogator, or a primary tag circuit adapted to deactivate its own clocking circuit is within the spirit and scope of the present invention.

In a fourth embodiment of the present invention, the clock control circuit 32 is further adapted to receive a wake-up command from the RFID interrogator (not shown) and to provide a start-clock signal to the primary tag circuitry 24 via the control line (c). In other words, the clock control circuit 32 is adapted to activate the primary tag circuitry's clock (and therefore activate the primary tag circuitry 24) in response to receiving the wake-up command.

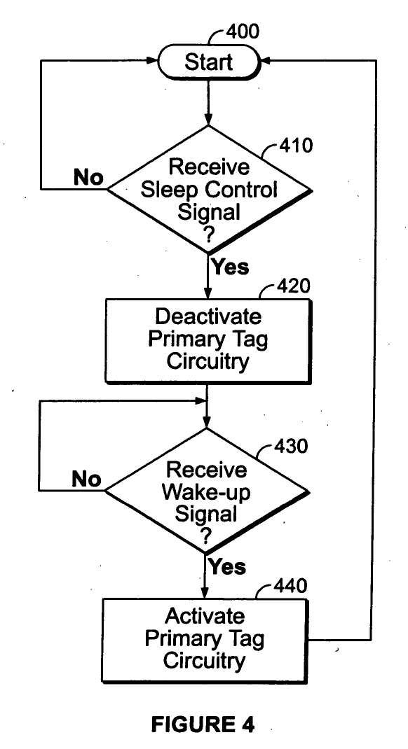

A method of operating an RF transponder in accordance with one embodiment of the present is illustrated in FIG. 4. Specifically, starting at step 400, the RF transponder, or more particularly a circuit located therein (e.g., power control circuit, clock control circuit, etc.) is adapted to determine whether a sleep signal (or command) has been received at step 410. If the answer is NO, the process begins again at step 400. If a sleep signal (or command) has been received, the primary tag circuitry is deactivated at step 420. This may be performed, for example, by disabling the primary tag circuitry's clock (e.g., using a stop-clock command, etc.), disconnecting the circuitry from its power supply (e.g., by toggling a power switch, etc.), etc. At step 430, the circuit is adapted to determine whether a wake-up signal (or command) has been received. If the answer is NO, then this step is repeated and the primary tag circuitry remains deactivated. If a wake-up signal (or command) has been received, the primary tag circuitry is activated at step 440, and the process begins again at step 400.

Having thus described several embodiments of a system and method of using a “sleep” command to place at least a portion of the RF transponder circuitry into a “sleep” mode, it should be apparent to those skilled in the art that certain advantages have been achieved. It should also be appreciated that various modifications, adaptations, and alternative embodiments thereof may be made within the scope and spirit of the present invention. It should be appreciated that the present invention is directed primarily toward the use of a “sleep” command (or signal) to place at least a portion of the RF transponder circuitry into a “sleep” mode, and not toward any one method of performing such a function. Thus, it should be appreciated that the present invention is not limited to the aforementioned methods of deactivating at least a portion of the RF transponder circuitry, and further includes all methods generally known to those skilled in the art.

What is claimed is:

1. An RF transponder, comprising:
a primary circuit adapted to receive and process RF signals;
a power control circuit in electrical communication with the primary circuit;
an antenna in electrical communication with the primary circuit and the power control circuit;
a power supply operatively coupled to the primary circuit and the power control circuit; and
a switch coupled to the power supply, the primary circuit, and the power control circuit, wherein:
the primary circuit is operatively connected to the power supply when the switch is in a first state, and disconnected from the power supply when the switch is in a second state;
the primary circuit is further adapted to provide a sleep signal to the power control circuit upon detecting a sleep command in one of the received RF signals; and
the power control circuit is adapted to toggle the switch from the first to the second state upon receiving the sleep signal, thereby deactivating the primary circuit to reduce power consumption by the RF transponder.

2. The RF transponder of claim 1, further comprising a voltage regulation circuit that is operatively coupled to the primary circuit and the power supply, and adapted to regulate the voltage provided by the power supply.

3. The RF transponder of claim 1, wherein the primary circuit is adapted to receive RF signals originating from one or more RFID interrogators.

4. The RF transponder of claim 1, wherein:
the primary circuit is further adapted to provide a wake-up signal to the power control circuit upon detecting a wake-up command in one of the received RF signals; and
the power control circuit is further adapted to toggle the switch from the second to the first state upon receiving the wake-up signal, thereby activating the primary circuit.

5. The RF transponder of claim 1, wherein the primary circuit comprises receive/transmit circuits, signal processing logic, and a memory.

6. The RF transponder of claim 1, wherein the power supply is located on board the RF transponder.

7. The RF transponder of claim 6, wherein the power supply comprises a battery.

8. The RF transponder of claim 1, wherein the power supply extracts power from received RF signals.

9. The RF transponder of claim 1, wherein the switch comprises at least one transistor.

10. An RF transponder, comprising:
a primary circuit adapted to receive and process RF signals;
a clock control circuit in electrical communication with the primary circuit;
an antenna in electrical communication with the primary circuit and the clock control circuit; and
a power supply operatively coupled to the primary circuit and the clock control circuit, wherein:
the primary circuit is further adapted to provide a sleep signal to the clock control circuit upon detecting a sleep command in one of the received RF signals;
the clock control circuit is adapted to transmit a stop-clock signal to the primary circuit upon receiving the sleep signal; and
the stop-clock signal disables a clock of the primary circuit, thereby deactivating the primary circuit to reduce power consumption by the RF transponder.

11. The RF transponder of claim 10, further comprising a voltage regulation circuit that is operatively coupled to the primary circuit and the power supply, and adapted to regulate the voltage provided by the power supply.

12. The RF transponder of claim 10, wherein the primary circuit is adapted to receive RF signals originating from one or more RFID interrogators.

13. The RF transponder of claim 10, wherein:
the primary circuit is further adapted to provide a wake-up signal to the clock control circuit upon detecting a wake-up command in one of the received RF signals; and
the clock control circuit is further adapted to provide a start-clock signal to the primary circuit to activate the clock, thereby activating the primary circuit.

14. The RF transponder of claim 10, wherein the primary circuit comprises a receive/transmit circuit, signal processing logic, and a memory.

15. The RF transponder of claim 10, wherein the power supply is located on board the RF transponder.

16. The RF transponder of claim 10, wherein the power supply comprises a battery.

17. The RF transponder of claim 10, wherein the power supply extracts power from received RF signals.

18. The RF transponder of claim 10, wherein the switch comprises at least one transistor.

19. The RF transponder of claim 10, wherein the clock comprises a clocking circuit.

20. The RF transponder of claim 10, wherein the switch comprises an oscillation circuit.

21. The RF transponder of claim 10, wherein the clock control circuit is further adapted to receive RF signals and disable the clock upon detecting the sleep command in one of the received RF signals.

22. A method of operating an RF transponder, comprising:
receiving one or more RF signals;
determining whether one of the RF signals comprises a sleep command;
deactivating a primary circuit adapted to receive and process incoming RF signals upon determining that one of the received RF signals comprises the sleep command;
determining whether one of the received RF signals comprises a wake-up command; and
activating the primary circuit upon determining that one of the received RF signals comprises the wake-up command.

23. The method of claim 22, wherein receiving the one or more RF signals comprises receiving the RF signals from one or more RF interrogators.

24. The method of claim 22, wherein deactivating the primary circuit comprises disconnecting a power supply from the primary circuit.

25. The method of claim 22, wherein deactivating the primary circuit comprises disabling a clock of the primary circuit.

26. The method of claim 22, wherein activating the primary circuit comprises connecting the power supply to the primary circuit.

27. The method of claim 22, wherein activating the primary circuit comprises activating the clock of the primary circuit.
